(19) United States
(12) Patent Application Publication
(10) Pub. No.: US 2011/0099058 A1
(43) Pub. Date: Apr. 28, 2011

(54) System for Providing Classified Advertisement

(75) Inventor: Chi-Chen CHENG, Taipei City (TW)

(73) Assignee: iPeer Multimedia International Ltd, Taipei City (TW)

(21) Appl. No.: 12/242,160

(22) Filed: Sep. 30, 2008

(30) Foreign Application Priority Data
Apr. 19, 2008 (TW) 097206123

(51) Int. Cl. G06Q 30/00

(52) U.S. Cl. 705/14.41

(57) ABSTRACT

Disclosed is a system for providing classified advertisement. The system includes a control device, a data device, a downloading device, an analyzing device and an advertisement-managing device. The data device is connected to the control device to provide data. The downloading device is connected to the control device to receive the data from the data device. The analyzing device is connected to the control device to analyze user-related information provided from the downloading device. The analyzing device includes a hardware-analyzing unit, a software-analyzing unit, an IP-analyzing unit and a content-analyzing unit. The advertisement-managing device is connected to the control device to provide advertisement to the downloading device based on the analysis by the analyzing device.

### FIELD OF INVENTION

The present invention relates to an on-line system for providing classified advertisement

### BACKGROUND OF INVENTION

People download multi-media data to their downloading devices such as desktop computers, laptop computers, mobile phones and personal digital assistants (“PDA”) from websites. The multi-media data may be ii transferred via email. The multi-media data may be stored in the hard disc drives or memory chips built in the downloading devices or USB storage devices or laser discs connected to the downloading devices. A keyboard or mouse can be used to instruct such a downloading device to play the multi-media data via software-based interface or hardware-based interface.

As the multi-media data are provided to and shown on the downloading devices, advertisement is also provided to and shown on the downloading devices synchronously. Alternatively, such advertisement may be provided as email later.

The advertisement is provided without classification. A user of such a downloading device receives a lot of advertisement which does not interest him or her. The user soon gets fed up with such advertisement and might deem such email junk mail. This practice annoys such users and wastes a lot of resource.

Therefore, the present invention is intended to obviate or at least alleviate the problems encountered in prior art.

### SUMMARY OF INVENTION

It is the primary objective of the present invention to provide a system for providing classified advertisement.

To achieve the foregoing objective, the system includes a control device, a data device, a downloading device, an analyzing device and an advertisement-managing device. The data device is connected to the control device to provide data. The downloading device is connected to the control device to receive the data from the data device. The analyzing device is connected to the control device to analyze user-related information provided from the downloading device. The analyzing device includes a hardware-analyzing unit, a software-analyzing unit, an IP-analyzing unit and a content-analyzing unit. The advertisement-managing device is connected to the control device to provide advertisement to the downloading device based on the analysis by the analyzing device.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a perspective view of a system for providing classified advertisement according to the preferred embodiment of the present invention.

FIG. 2 is a block diagram of the system shown in FIG. 1.

FIG. 3 is a detailed block diagram of the system shown in FIG. 2.

FIG. 4 is a block diagram of a business connected to the system shown in FIG. 3.

### DETAILED DESCRIPTION OF PREFERRED EMBODIMENT

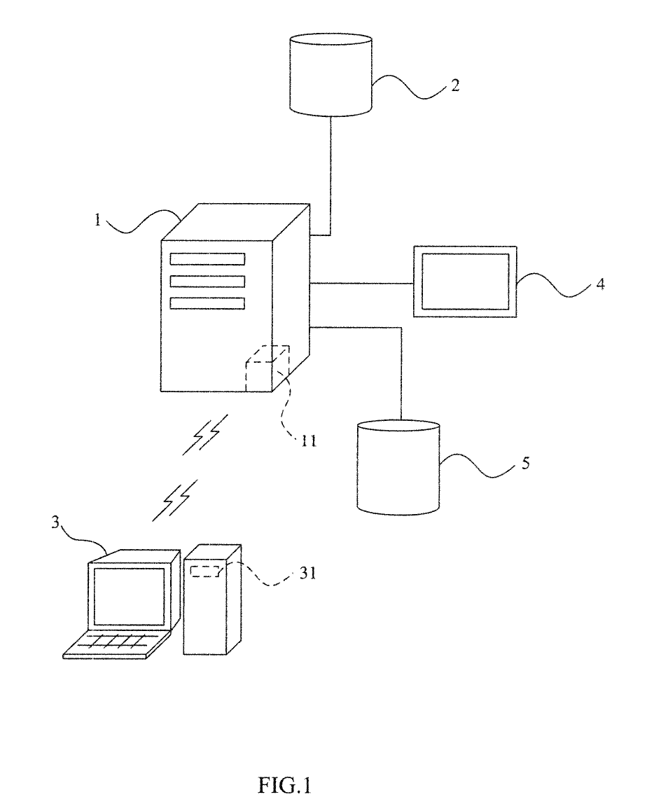

Referring to FIG. 1, there is shown a system for providing classified advertisement according to the preferred embodiment of the present invention. The system includes a control device 1, a data device 2, a downloading device 3, a judging device 4 and an advertisement-managing deice 5.

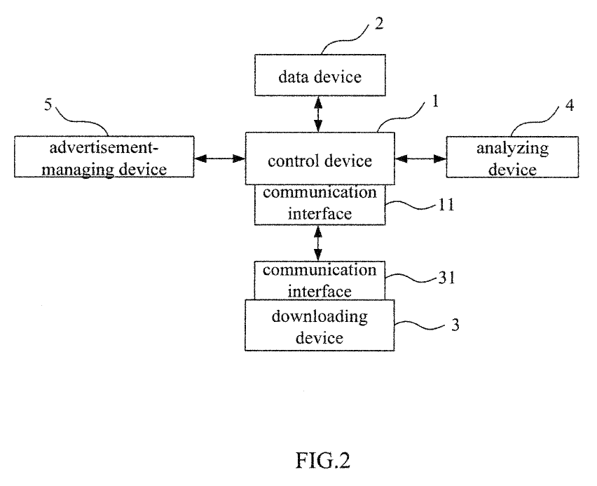

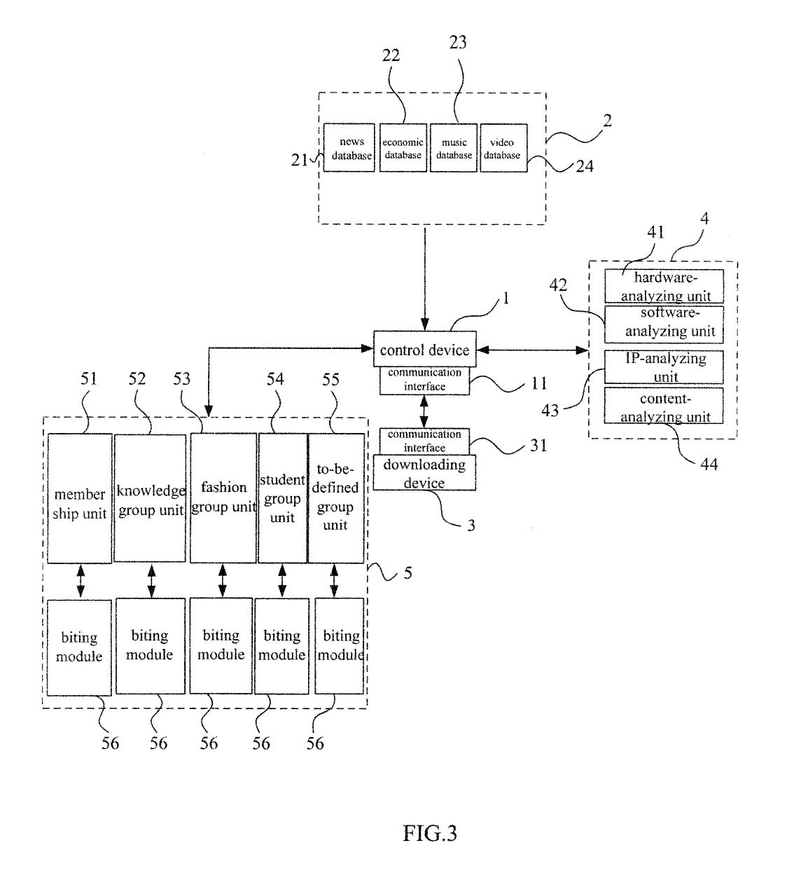

Referring to FIGS. 2 and 3, the control device 1 includes a communication interface 11. The communication interface 11 may be intended for cable-based communication or wireless communication.

The data device 2 is connected to the control device 1, and includes a news database 21, an economic data base 22, a music database 23 and a video database 24. Each of the news database 21, the economic data base 22, the music database 23 and the video database 24 may be a server.

The downloading device 3 includes a communication interface 31 for communication with the communication interface 11 of the control device 1 so that control device 1 can instruct the data device 2 to provide data to the downloading device 3. The communication interface 31 may be intended for cable-based communication or wireless communication corresponding to the communication interface 11. The downloading device 3 may be a desktop computer, a laptop computer, a mobile phone or a PDA.

The analyzing device 4 is connected to the control device 1, and includes a hardware-analyzing unit 41, a software-analyzing unit 42, an IP-analyzing unit 43 and a content-analyzing unit 44. The analyzing device 4 can analyze user-related information provided from the downloading device 3.

The advertisement-managing deice 5 is connected to the control device 1, and provides proper advertisement to the downloading device 3 according to the analysis by the analyzing device 4. The advertisement-managing device 5 includes a membership unit 51, a knowledge group 52, a fashion group unit 53, a student group unit 54 and a to-be-defined group unit 56. Each of the units 51 to 56 is connected to a biting module 56.

In use, the communication interface 31 of the downloading device 3 is connected to the communication interface 11 of the control device 1. The user enters personal information and a personal identification number (“PIN”). After confirming the personal information and the PIN, the control device 1 relays the data to the downloading device 3 from the news database 21, the economic database 22, the music database 23 or the video database 24 of the data device 2.

While the user is downloading the data to the downloading device 3 from the data device 2, the membership unit 51 of the advertisement-managing device 5 cooperates with the control device 1 to determine whether the user is a member. If so, the analyzing device 4 cooperates with the control device 1 to analyze the user-related information provided from the downloading device 3. The analysis is done by the hardware-analyzing unit 41, the software-analyzing unit 42, the IP-analyzing unit 43 and the content-analyzing unit 44. Based on the analysis with the analyzing device 4, the advertisement-managing device 5 provides advertisement to the downloading device 3 from the knowledge group unit 52, the fashion group unit 53, the student group unit 54 or the to-be-defined group unit 55. A few cases are described as follows.

The hardware-analyzing unit 41 analyzes the hardware of the downloading device 3 and recognizes the brand and model of the downloading device 3. If the downloading device 3 is of a famous brand and a new and expensive model, the analyzing device 4 determines that the user loves new stuff and is rich so that the advertisement-managing device 5 provides the advertisement of expensive and fashionable products to the downloading device 3. Otherwise, the advertisement-managing device 5 provides ordinary advertisement to the downloading device 3.

The software-analyzing unit 42 analyzes the hardware of the downloading device 3 and determines whether the software run in the downloading device 3 includes normal editions, trial editions, free-of-charge editions or illegal copies. If most of the software programs run in the downloading device 3 are trial or free-of-charge editions, the analyzing device 4 determines that the user loves discounted products and giveaways so that the advertisement-managing device 5 provides the advertisement of discounted products to the downloading device 3. Otherwise, the advertisement-managing device 5 provides the ordinary advertisement to the downloading device 3.

The IP-analyzing unit 43 analyzes the IP of the downloading device 3 and figures out the IP address, geographic location and identification of the user. After learning the geographic location of the user, the advertisement-managing device 5 provides the advertisement of products available near the geographic location of the user and advertisement particularly appealing to people near the geographic location of the user. If the analyzing device 4 determines the user to be a student, the advertisement-managing device 5 provides advertisement particularly appealing to students.

The content-analyzing unit 44 analyzes the content of the data previously downloaded to the downloading device 3 and learns the user's habits in reviewing and downloading. If the analyzing device 4 determines that the user is learned, the advertisement-managing device 5 provides the advertisement particularly appealing to learned people. Otherwise, the advertisement-managing device 5 provides the ordinary advertisement to the downloading device 3.

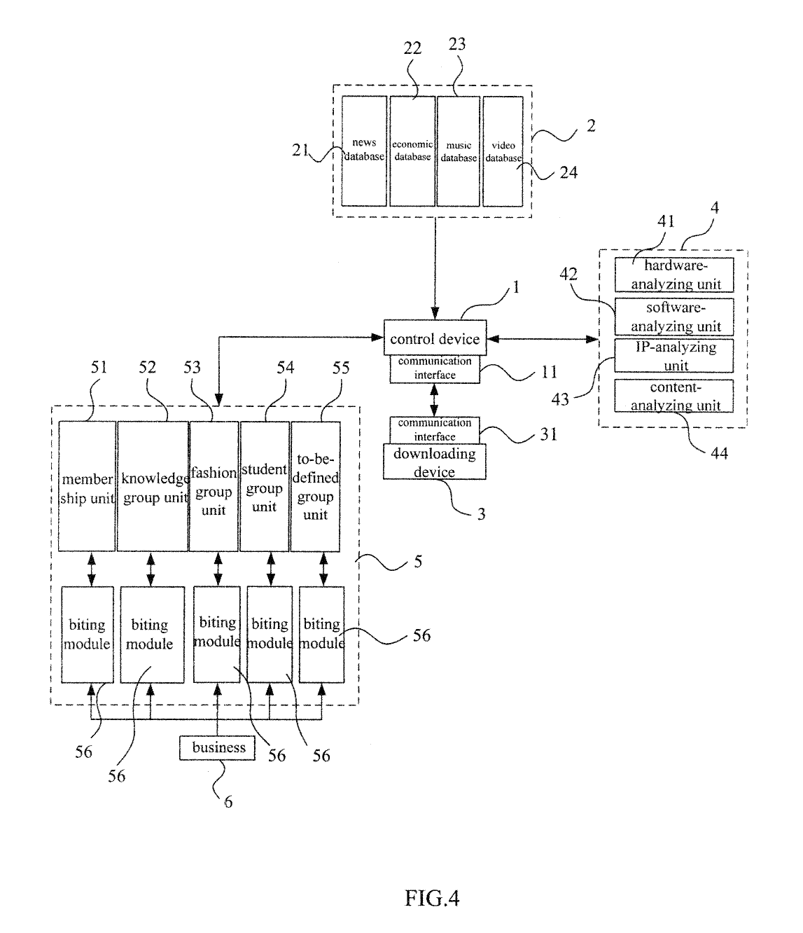

Referring to FIG. 4, a business 6 can be connected to the biting module 56 connected to each of the units 52 to 53. Thus, the business 6 can bit for the rights to provide advertisement.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A system for providing classified advertisement comprising:
a control device;
a data device connected to the control device to provide data;
a downloading device connected to the control device to receive the data from the data device;
an analyzing device connected to the control device to analyze user-related information provided from the downloading device, wherein the analyzing device comprises a hardware-analyzing unit, a software-analyzing unit, an IP-analyzing unit and a content-analyzing 1 unit; and
an advertisement-managing device connected to the control device to provide advertisement to the downloading device based on the analysis by the analyzing device.

2. The system according to claim 1, wherein the control device comprises a communication interface, wherein the downloading device comprises a communication interface corresponding to the communication interface of the control device.

3. The system according to claim 2, wherein the communication interfaces are designed for cable-based communication.

4. The system according to claim 2, wherein the communication interfaces are designed for wireless communication.

5. The system according to claim 1, wherein the data device comprises a news database, an economic database, a music database and a video database.

6. The system according to claim 1, wherein the news database, the economic database, the music database and the video database are servers.

7. The system according to claim 1, wherein the downloading device is selected from a group consisting of a desktop computer, a laptop computer, a mobile phone and a person digital assistant.

8. The system according to claim 1, wherein the advertisement-managing comprises a membership unit, a knowledge group unit, a fashion group unit, a student group unit and a to-be-defined group unit.

9. The system according to claim 8 comprising a biting module connected to each of the knowledge group unit, the fashion group unit, the student group unit and the to-be-defined group unit.
